(19) United States
(12) Patent Application Publication
(10) Pub. No.: US 2006/0086925 A1
(43) Pub. Date: Apr. 27, 2006

(54) Nanoparticle fluorescent material and dispersion of the same

(76) Inventors: Hiroyuki Hirai, Kanagawa (JP); Keiko Sugihara, Kanagawa (JP)

Correspondence Address: TAIYO CORPORATION, 401 HOLLAND LANE, #407, ALEXANDRIA, VA, 22314, US

(21) Appl. No.: 11/119,923

(22) Filed: May 3, 2005

(30) Foreign Application Priority Data
May 11, 2004 (JP) 2004-140817

(51) Int. Cl. C09K 11/08

(52) U.S. Cl. 252/301.4 R; 252/301.4 F; 252/301.6 F; 252/301.6 R

(57) ABSTRACT

A nanoparticle fluorescent material of metal oxide or metal sulfide which is surface modified by a surface modification agent, wherein a half width of emission spectrum is 50 to 200 nm, and the surface modification agent is a compound represented by formula (I) or a degradation product thereof, and a dispersion of the same.
M-(R)₄ formula (I) In formula (I), M is an Si or Ti atom, and R is an organic group. The R groups may be the same or different from each other, but at least one R group is a group having reactivity with an affinity molecule.

### CROSS-REFERENCE TO RELATED APPLICATION

This application claims priority under 35 USC 119 from Japanese Patent Application No. 2004-140817, the disclosure of which is incorporated by reference herein.

### BACKGROUND OF THE INVENTION

1. Field of the Invention

The present invention relates to a nanoparticle fluorescent material applicable to a fluorescent labeled material and a dispersion of the same, particularly to a nanoparticle fluorescent material which is highly safe for towards the environment and living organisms, and a dispersion of the same.

2. Description of the Related Art

It is known that nano-sized particle materials show properties different from those of bulky materials. For example, so-called quantum size effects are well known, where, for example, for semiconductors the band gap, which has been traditionally considered as unique to the materials, actually varies depending on the particle size. The size of particles in which the effect is exhibited significantly varies depending on the type of semiconductor material, and is generally of the order of some tens nm or below. Therefore, for exhibiting this effect, particles at the single nano level are significant. It is known that some materials have effects such as, for example, at the size that quantum size effects become significant, the lifetime of fluorescence is shortened, or emission that has not been observed before can be observed. As described above, since nano-sized materials, particularly single nano-sized materials have properties different from traditionally known bulk materials, they are attracting significant attention in science and engineering.

For example, a semiconductor nanoparticle fluorescent material for detecting a target molecule is proposed whereby semiconductor nanoparticles such as CdSe/CdS (core/shell) and CdSe/ZnS (core/shell) are used to prepare beads and a molecular probe is bonded to the bead surface (for example, see Science, vol. 281, No. 25, pp. 2013-2016, (1998), and Nature Biotechnology, vol. 19, pp. 631-6354 (2001)). Emission at different wavelengths can be obtained using these semiconductor nanoparticles by varying the crystallite size. By selecting emission wavelengths and emission intensities and using labeled beads coded by emission wavelength and emission intensity, a simultaneous multiplex measurement can be conducted. Semiconductor nanoparticle fluorescent materials have excellent characteristics for labeled material that is highly sensitive, inexpensive and easily automated. Therefore, semiconductor nanoparticle fluorescent materials are used as labeled materials to detect substances in specified sites or in the blood plasma of living organisms with high sensitivity and high speed.

Semiconductor nanoparticle fluorescent materials are proposed wherein the surface of a semiconductor nano particle is coated with a modifying molecule to improve the affinity to a matrix (for example, U.S. Pat. No. 6,319,426, Japanese Patent Application Laid-open (JP-A) Nos. 2002-38145 and 2003-64278, and Science, vol. 281, 25, pp. 2016-2018, (1998)). By coating the semiconductor nanoparticle with the modifying molecule, it becomes possible, for example, to improve the affinity to an aqueous medium, and the dispersibility in organic polymers and organic solvents. Thus, it is facilitated to apply the semiconductor nanoparticle fluorescent material as a labeled material. As described above, semiconductor nanoparticle fluorescent materials are expected to be widely applicable in fields such as clinical diagnosis and biochemical and medical science research.

However, from the viewpoint of safety and the environment, there is a problem in the use of semiconductor nanoparticle fluorescent materials such as CdSe or CdSe/ZnS (core/shell). On this account, it is desired to replace them by a material which is safe and has less impact on the environment.

A ZnS nanoparticle fluorescent material, doped with Mn²⁺ and the like, has the characteristic that its emission wavelength can be varied by the kind of doping metal ions and surface modifying molecules (surface modification agents). It is useful as a replacement of semiconductor nanoparticle fluorescent materials such as CdSe or CdSe/ZnS (core/shell) because it is easily synthesized in a solvent such as water (for example, see JP-A No. 2002-322468, Journal of Illuminating Engineering Institute of Japan, vol. 87, No. 4, pp. 256-261 (2003), and Journal of The Electrochemical Society, vol. 149, No. 3, pp. H72-H75 (2002)).

Since the crystallite size of a metal oxide nanoparticle fluorescent material such as ZnO can relatively easily be varied, and can be doped with a metal such as Eu³⁺, various emission wavelengths can be obtained (see Advanced Functional Materials, vol. 13, No. 10, pp. 800-804, (2003)).

In order to apply nano particles of metal oxide or metal sulfide to fluorescent labeled materials, it is desirable that a compound having an amino group or carboxyl group (or precursors thereof) is bonded to the surface as a surface modification agent. Further, the surface modification agent desirably has a function of preventing the elution of the nanoparticle fluorescent material and the quenching of fluorescence by body fluids.

On the other hand, from the viewpoint of a detection apparatus, by narrowing the half width of fluorescence of a labeled material, a plurality of materials of different wavelengths can be used at the same time (see JP-A No. 2000-275180). However, there is a problem that the detection sensitivity is decreased unless the detection wavelength of the light-receiving device is optimized. Counter measures dramatically increase the complexity and cost of the apparatus, which is not always desirable for a system.

### SUMMARY OF THE INVENTION

Therefore, there is the need for a nanoparticle fluorescent material which is excellent in dispersibility, and a dispersion of the same, particularly a nanoparticle fluorescent material of metal oxide or metal sulfide which has highly sensitive, uniform emission properties, is safe, has less impact on the environment, and is easily functionalized, and a dispersion of the same. Furthermore, there is the need for a fluorescent labeled material which can be used in a simple device to detect substances in specified sites or in blood plasma in a living organism with high sensitivity at high speed.

In view of these circumstances, the inventors have carried out intensive research, and consequently found that by using a compound represented by formula (I) or a degradation product thereof as a surface modification agent, a nanoparticle fluorescent material of metal oxide or metal sulfide, which has excellent dispersibility and high sensitivity, uniform emission properties of a wide half width and is easily functionalized, can be obtained. The present invention thus has been made.

More specifically, one aspect of the invention is to provide a nanoparticle fluorescent material of metal oxide or metal sulfide which is surface modified by a surface modification agent, wherein a half width of emission spectrum is 50 to 200 nm, and the surface modification agent is a compound represented by formula (I) or a degradation product thereof.
M-(R)₄ formula (I)

In formula (I), M is an Si or Ti atom, and R is an organic group. The R groups may be the same or different from each other, but at least one R group is a group having reactivity with an affinity molecule.

A second aspect of the invention is to provide a nanoparticle fluorescent material dispersion, wherein the nanoparticle fluorescent material according to the first aspect is dispersed in water or a hydrophilic solvent.

### BRIEF DESCRIPTION OF THE DRAWINGS

FIG. 1 is a diagram illustrating a photoluminescence spectrum (Example 1).

### DETAILED DESCRIPTION OF THE INVENTION

1. Surface Modification Agent

In the present invention, a compound represented by formula (I) below or a degradation product thereof (hereinafter, referred to as ‘a surface modification agent used in the invention’) is used as a surface modification agent to surface modify a nano particle fluorescent material of metal oxide or metal sulfide. Accordingly, the dispersibility of the nanoparticle fluorescent material in water or a hydrophilic solvent can be improved, and the elution of the nanoparticle fluorescent material and the quenching of fluorescence by body fluids can be prevented. Furthermore, it has an advantage of easily bonding to a molecular probe for detecting a target molecule. Hereinafter, the surface modification agent used in the invention will be described. The surface modification agent used in the invention is a compound represented by formula (I) below or a degradation product thereof.
M-(R)₄ formula (I)

In the formula, M is a Si or Ti atom, and R is an organic group. The R groups may be the same or different from each other, but at least one R group is a group having reactivity with an affinity molecule.

Among the organic groups represented by R, the group(s) having reactivity with an affinity molecule is a group having, at a terminal, a vinyl group, allyloxy group, acryloyl group, methacryloyl group, isocyanato group, formyl group, epoxy group, maleimide group, mercapto group, amino group, carboxyl group, halogen, or the like bonded through a linking group L. Among the groups having reactivity with an affinity molecule, those having an amino group at the terminal thereof are particularly preferable.

Examples of the linkage group L include alkylene groups (chain or cyclic groups having 1 to 10 carbon atoms, preferably having 1 to 8 carbon atoms, such as a methylene group, ethylene group, trimethylene group, tetramethylene group, hexamethylene group, propylene group, ethylethylene group, and cyclohexylene group).

The linking group L may have an unsaturated bond. Examples of unsaturated groups include alkenylene groups (chain or cyclic groups having 1 to 10 carbon atoms, preferably having 1 to 8 carbon atoms, such as a vinylene group, propenylene group, 1-butenylene group, 2-butenylene group, 2-pentenylene group, 8-hexadecenylene group, 1,3-butanedienylene group, and cyclohexenylene group), and arylene groups (arylene groups having 6 to 10 carbon atoms such as a phenylene group and naphthylene group, preferably a phenylene group having 6 carbon atoms).

The linking group L may have one or more heteroatoms (a heteroatom means any atom other than a carbon atom; such as a nitrogen atom, oxygen atom, or sulfur atom). Preferably, the heteroatom is an oxygen atom or sulfur atom, most preferably an oxygen atom. The number of hetero atoms is not particularly limited, but it is preferably five or below, more preferably three or below.

The linking group L may include, as a partial structure, a functional group containing a carbon atom adjacent to the heteroatom. Examples of the functional group include an ester group (including a carboxylic acid ester, carbonic ester, sulfonic acid ester, and sulfinic acid ester), amide group (including a carboxylic acid amide, urethane, sulfonic acid amide, and sulfinic acid amide), ether group, thioether group, disulfide group, amino group, and imide group. The functional groups above may further have a substituent. The linking group L may include a plurality of such functional groups. When the linking group L includes a plurality of such functional groups, these functional groups may be the same or different from each other.

The functional group is preferably an ester group, amide group, ether group, thioether group, disulfide group, or amino group, and more preferably an alkenyl group, ester group, or ether group.

The R groups other than the group(s) having reactivity to an affinity molecule may be any group, but preferably an alkoxy group or phenoxy group, such as a methoxy group, ethoxy group, isopropoxy group, n-propoxy group, t-butoxy group, and n-butoxy group. The alkoxy group and phenoxy group may further have a substituent, but desirably the total carbon number is eight or below.

The surface modification agent used in the invention may be a compound in which an amino group, carboxyl group, or the like forms a salt with an acid or base.

The degradation products of a compound represented by formula (I) among the surface modification agents used in the invention include hydroxides produced by hydrolysis of an alkoxy group, low molecular weight oligomers produced by dehydration condensation reaction between hydroxyl groups (the oligomers may have any of linear, cyclic, or crosslinking structures), dealcoholization condensation reaction products of a hydroxyl group and an unhydrolyzed alkoxy group, and sols and gels that are products produced by dehydration condensation reaction of the above products.

Specific examples of the surface modification agents used in the invention include the following compounds, but the agents are not limited to these compounds:

N-(2-aminoethyl)-3-aminopropylmethyldimethoxy silane, N-(2-aminoethyl)-3-aminopropyltrimethoxy silane, N-(2-aminoethyl)-3-aminopropyltriethoxy silane, 3-aminopropyltrimethoxy silane, aminophenyltrimethoxy silane, 3-aminopropyltriethoxy silane, bis(trimethoxysilylpropyl)amine, N-(3-aminopropyl)-benzamidetrimethoxy silane, 3-hydrazidepropyltrimethoxy silane, 3-maleimidepropyltrimethoxy silane, (p-carboxy)phenyltrimethoxy silane, 3-carboxypropyltrimethoxy silane, 3-aminopropyltitaniumtripropoxide, 3-amino propylmethoxyethyltitaniumdiethoxide, and 3-carboxypropyltitaniumtrimethoxide.

The surface modification agent used in the invention may be a compound in which an NH₂ group or COOH group at the terminal forms salt with an acid or base.

The surface modification agent used in the invention may coat over the entire surface of a nanoparticle fluorescent material or be bonded to part of the surface. One surface modification agent or a plurality of surface modification agents in combination may be used in the invention.

In addition to the surface modification agents used in the invention, conventional surface modification agents (such as polyethylene glycol, polyoxyethylene(1)laurylether phosphate, laurylether phosphate, trioctylphosphine, trioctylphosphineoxide, sodium polyphosphate, and sodium bis(2-ethylhexyl) sulfosuccinate) may coexist with the surface modification agent used in the invention when synthesizing the nanoparticles or after synthesizing them.

2. Nanoparticle Fluorescent Material of Metal Oxide or Metal Sulfide

The nanoparticle fluorescent material of metal oxide or metal sulfide in the invention is not particularly limited as long as it emits fluorescence having a half width of 50 to 200 nm. Examples of metals forming the metal oxide or metal sulfide, include metals of the IIB group such as Zn, metals of the IIIA group such as Y, Eu and Tb, metals of the IIIB group such as Ga and In, metals of the IVA group such as Zr and Hf, metals of the IVB group such as Si and Ge, metals of the VA group such as V and Nb, and metals of the VIA group such as Mo and W. Among them, Zn, which is gentle to living organisms, is particularly preferable. The metal oxide may be a composite metal oxide such as Zn₂SiO₄, CaSiO₃, MgWO₄, YVO₄, and Y₂SiO₅.

The nanoparticle fluorescent material of metal oxide or metal sulfide preferably contains a slight amount of a metal ion which is different from the metal in the metal oxide or metal sulfide. Examples of such metal ions contained in a slight amount include Mn, Cu, Eu, Tb, Tm, Ce, Al, and Ag. It is also preferable that the nanoparticle fluorescent material of the invention is doped with a compound obtained by combining such metal ions with a chloride ion or fluoride ion. The nanoparticle fluorescent material of the invention may be doped with a metal ion of a single kind of atom or metal ions of two or more kinds of atoms. The optimum concentration of the metal ion depends on the metal forming the nanoparticle fluorescent material (the metal forming the metal oxide or metal sulfide) and the kind thereof, but is preferably in the range of 0.001 to 10 atom %, more preferably in the range of 0.01 to 10 atom % with respect to the metal oxide or metal sulfide.

The nanoparticle fluorescent material of metal oxide or metal sulfide in the invention has a half width of emission spectrum of 50 to 200 nm. Preferably, it is 60 to 180 nm in order to detect emission highly sensitively using a simple apparatus. It is necessary that a fluorescent labeling material has a peak emission wavelength different from a peak absorption wavelength. In order to detect emission highly sensitively, for the nanoparticle fluorescent material of metal oxide or metal sulfide in the invention, its peak emission wavelength is preferably separated from the edge of its absorption wavelength by 20 nm or greater, more preferably 50 nm or greater. The nanoparticle fluorescent material having peak wavelength and half width of emission spectrum like these can be obtained as a nanoparticle fluorescent material of metal oxide or metal sulfide, by selection of the metal forming the material as described above.

Preferably, the nanoparticle fluorescent material of metal oxide or metal sulfide in the invention is a nanoparticle fluorescent material of metal oxide that is easily coated by the surface modification agent used in the invention.

The number average particle diameter of the nanoparticle fluorescent material of the invention is preferably 0.5 to 100 nm, more preferably 0.5 to 50 nm, even more preferably 1 to 10 nm. The coefficient of variation of the particle diameter distribution of the nanoparticle fluorescent material is preferably 0 to 50%, more preferably 0 to 20%, even more preferably 0 to 10%. The coefficient of variation means a value of the arithmetic standard deviation when divided by the number average particle diameter and is expressed as a percentage (arithmetic standard deviation×100/number average particle diameter).

3. A Method of Producing the Nanoparticle Fluorescent Material and the Dispersion of the Same

The metal oxide nanoparticle fluorescent material of the invention can be obtained by solution-phase synthesis method such as a sol-gel method in which an organic metal compound of alkoxide and acetylacetonate of the metal, which as a precursor, is hydrolyzed, a hydroxide precipitation method in which an alkaline is added to an aqueous solution of a salt of the metal to precipitate a hydroxide followed by dehydration and annealing, an ultrasonic degradation method in which the precursor solution of the metal has ultrasound applied thereto, a solvothermal method that conducts a degradation reaction under high temperature and high pressure, and a spray pyrolysis method that uses a spray at high temperature. The nanoparticle fluorescent material can also be obtained by vapor-phase synthesis method such as a method using an organic compound (for example, thermal CVD method and plasma CVD method), and a method using a target of the metal or the metal oxide (for example, a sputtering method and a laser ablation method).

The metal sulfide nanoparticle fluorescent material of the invention can be obtained by a solution-phase synthesis method such as: a hot soap method, in which a heat decomposable metal compound such as a diethyl-dithiocarbamate compound of the metal is crystal grown in a high boiling point organic solvent such as trialkylphosphineoxides, trialkylphosphines, ω-aminoalkanes; a coprecipitation method in which a sulfide solution such as sodium sulfide or ammonium sulfide is added to a solution of a salt of the metal to grow crystals; a reversed micelle method in which a raw material aqueous solution containing a surfactant is made to exist as a reversed micelle in a nonpolar organic solvent such as alkanes, ethers, and aromatic hydrocarbons and is crystal grown in the reversed micelle. The nanoparticle fluorescent material can also be obtained by one of the vapor-phase synthesis methods described as methods for forming the metal oxide nanoparticle fluorescent material.

Whilst the surface modification agent used in the invention can be added in synthesis of the nanoparticle fluorescent material, preferably it is added after synthesis. At least part of the surface modification agent is hydrolyzed to be bonded to the nanoparticle fluorescent material, and coats (surface modifies) over at least part of the surface of the nano particle. The nanoparticle fluorescent material may be washed and purified by a normal method, such as centrifuge separation and filtration, and then dispersed in a solvent containing the surface modification agent used in the invention (preferably, a hydrophilic organic solvent such as methanol, ethanol, isopropyl alcohol, and 2-ethoxyethanol) for coating.

The added amount of the surface modification agent used in the invention is varied depending on the particle size of fluorescent materials, the concentration of particles, and the types of surface modification agents (size and structure), but it is preferably 0.001 to 10 fold mol, more preferably 0.01 to 2 fold mol with respect to the metal oxide or metal sulfide.

In the invention, in addition to the surface modification agent used in the invention (a compound represented by formula (I) or a degradation product thereof), conventional surface modification agents can also be used as described above. The added amount of the conventional surface modification agent is not particularly limited, but preferably 0.01 to 100 fold mol, more preferably 0.05 to 10 fold mol with respect to the metal oxide or metal sulfide.

The concentration of the nano particle in a dispersion of the nanoparticle fluorescent material to which the surface modification agent is bonded is not particularly limited because the fluorescence intensity varies, but preferably 0.01 mM to 1000 mM, more preferably 0.1 mM to 100 mM. As the dispersion medium, besides above-described alcohols, a hydrophilic organic solvent such as DMF, DMSO, and THF and water are preferable.

The fact that the surface of the nanoparticle fluorescent material is coated with the surface modification agent can be confirmed by chemical analysis and by the presence of a constant interval between the particles when observed by a high-resolution TEM such as an FE-TEM.

When the nanoparticle fluorescent material coated with the surface modification agent represented by formula (I) further undergoes amidation reaction with nucleic acids (such as monomer and oligonucleotides), antibodies (monoclonal and other proteins (amino acids)), and affinity molecules such as polysaccharides using an amino or carboxyl terminal group of the surface modification agent as a reaction group, the nanoparticle fluorescent material forms a peptide linkage. Thus, the nanoparticle fluorescent material can function as a fluorescent labeled substance for specific molecules, etc. in a living organism.

Therefore, the nanoparticle phosphorescent material of the invention may be a material further bonded with a functional molecule.

The amidation reaction is conducted by condensation of a carboxyl group or its derivative group (esters, acid anhydrides, and acid halides) with an amino group. When an acid anhydride or acid halide is used, it is preferable that a base coexists with the acid anhydride or acid halide. When an ester such as methyl ester or ethyl ester of carboxylic acid is used, heating and decompression are desirably conducted for removing generated alcohol. When a carboxyl group is directly amidated, substances which promote amidation reaction, such as an amidation reagent (for example, DCC, Morpho-CDI, and WSC), a condensation additive (for example, HBT), an active ester agent (for example, N-hydroxyphthalimide, p-nitrophenyltrifluoroacetate, and 2,4,5-trichlorophenol), may be made to be present at the reaction, or may be made to undergo a reaction with the carboxyl group beforehand. In amidation reaction, desirably, any one of the amino groups or carboxyl groups of the affinity molecule to be bonded by amidation is protected by an appropriate protecting group in accordance with a standard method, and after reaction the protection is removed.

The nanoparticle fluorescent material bonded with the affinity molecule by amidation reaction is washed and purified by a standard method such as gel filtration, and then it is dispersed in water or a hydrophilic solvent (preferably, methanol, ethanol, isopropanol, or 2-ethoxyethanol) for use. The concentration of the nanoparticle fluorescent material in the dispersion is not particularly limited because the fluorescence intensity varies, but preferably is 10⁻¹ M to 10⁻¹⁵ M, more preferably 10⁻² M to 10⁻¹⁰ M.

### EXAMPLES

The invention will be described further in detail by examples below, but the invention is not limited thereto.

### Example 1

Synthesis of the Surface Modified Metal Oxide Nanoparticle Fluorescent Material

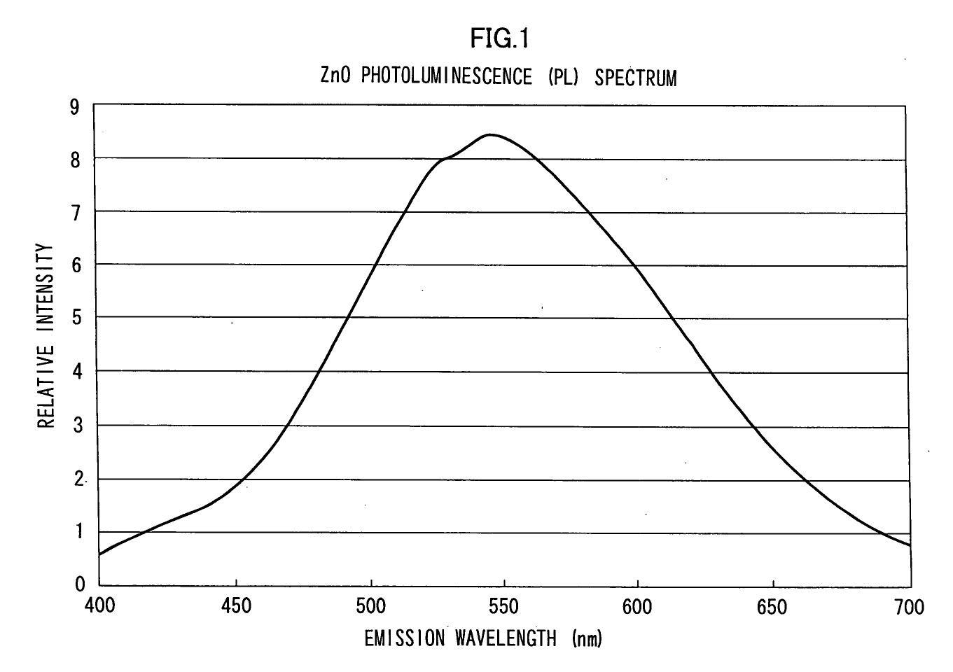

8.8 g of zinc acetate 2 hydrate was dissolved in 400 ml of dehydrated ethanol, and 240 ml was distilled off while refluxing at a temperature of 93° C. for two hours. 240 ml of dehydrated ethanol was added and the mixture was cooled to room temperature. 18 ml of a 25 mass % methanol solution of tetramethylammonium hydroxide was added and the resultant solution was agitated for 30 minutes. 7.2 ml of 3-aminopropyltrimethoxy silane and 2.2 ml of water were added and agitated at a temperature of 60° C. for four hours. A white precipitate generated was filtered, washed with ethanol, and then dried. It was revealed that the precipitate was a ZnO nanoparticle having the average particle diameter of about 4 nm by analysis with XRD and TEM. It was confirmed that Si and aminopropyl group(s) were bonded to the surface of the ZnO particles by elemental analysis and IR spectrophotometry. Water was added to the precipitate to prepare a 2 mass % aqueous dispersion. FIG. 1 shows the fluorescent spectra when light of 370 nm was irradiated onto the dispersion. Strong fluorescence was demonstrated as a broad peak having a peak wavelength of 540 nm and half width of 145 nm.

### Example 2

Dispersion of a Metal Oxide Nanoparticle Fluorescent Material to Which a Functional Molecule is Bonded

NaHCO₃ was added to the aqueous dispersion of the ZnO nanoparticle fluorescent material prepared in Example 1 so as to be 0.1 mass %, and the pH was made 7.5. A 1 mass % aqueous solution of sulfosuccinimidyl D-biotin (manufactured by Dojindo Laboratories) was added as a biotin labeling agent thereto for amidation reaction. The resultant was purified by gel filtration to prepare an aqueous dispersion of 10⁻⁴ M of ZnO nanoparticle fluorescent material to which biotin was bonded as a functional molecule. It was revealed that this dispersion can be applied to detecting avidin.

### Example 3

A metal oxide nanoparticle fluorescent material was synthesized in the same manner as Example 1 except that equimolar amounts of the surface modification agents shown in Table 1 were used instead of 3-aminopropyltrimethoxy silane. The relative fluorescence intensity and half width are shown in Table 1. As is revealed in Table 1 the surface modification agents of the invention demonstrated excellent emission properties.

TABLE 1

| | Relative | Half | |
|---|---|---|---|
| Surface | fluorescence | width | |
| modificationagent | intensity | (nm) | Remarks |
| N-(2-aminoethyl)-3- | A | 150 | the invention |
| Aminopropylmethyl | | | |
| tri-methoxy silane | | | |
| N-(3-aminopropyl)- | A | 140 | the invention |
| benzamidetrimethoxy | | | |
| silane | | | |
| 3-aminopropyltitanium | B | 125 | the invention |
| tripropoxide | | | |
| 3-aminopropanethiol | C | — | Comparative |
| | | | example |

In relative fluorescence intensity, A: strong fluorescence, B: relatively strong fluorescence, C: nearly no fluorescence

### Example 4

Synthesis of the Surface Modified Metal Sulfide Nanoparticle Fluorescent Material

21.3 g of sodium bis(2-ethylhexyl)sulfosuccinate (AOT) and 5.2 g of water were added to 150 ml of n-heptane, and a homogenizer was used to agitate and mix the mixture at 3000 rpm for 10 minutes to prepare micell solution I.

133 mg of sulfide sodium 9 hydrate was weighed and added to 20 ml of the micell solution I and mixed. This solution was solution A.

100 mg of zinc acetate and 12 mg of manganese acetate 4 hydrate were weighed and added to 80 ml of the micell solution I and mixed. This solution was solution B.

A homogenizer was used to agitate the solution B at 3000 rpm for 10 minutes, and the solution A was added therein and further agitated for 10 minutes for mixing. It was confirmed that a ZnS:Mn colloidal dispersion having an average particle diameter of about 3 nm was formed, by analysis by XRD and TEM. 300 ml of a 3% methanol solution of 3-mercaptoropyltrimethoxy silane was added thereto, gently stirred, and then allowed to stand. A precipitate was separated by decantation and washed with methanol. 50 ml of an ethanol solution containing 0.1 g of 3-aminopropyltrimethoxy silane was added to the precipitate, 1 ml of a 25 mass % methanol solution of tetramethylammonium hydroxide and 0.5 ml of water were further added, and the mixture was subjected to reflux at a temperature of 60° C. for four hours. A precipitate generated was filtered and washed with methanol, and then 50 ml of water was added and dispersed. A ZnS:Mn colloidal aqueous dispersion was obtained that was surface modified with silica having a 3-aminopropyl group on the surface.

Fluorescent spectra were measured at an excitation wavelength of 325 nm. Strong orange emission of a half width of 65 nm having its maximum near 590 nm was observed.

### Example 5

Dispersion of a Metal Sulfide Nanoparticle Fluorescent Material to Which a Functional Molecule is Bonded

In the same manner as in Example 2, the dispersion obtained in Example 4 was used to prepare 10⁻⁴ M of a ZnS:Mn nano particle fluorescent material aqueous dispersion to which biotin was bonded as a functional molecule. It was revealed that this dispersion can be applied to the detection of avidin.

The nanoparticle fluorescent material of the invention can provide a stable aqueous or hydrophilic organic solvent colloidal dispersion. The dispersion of the metal oxide or metal sulfide nanoparticle fluorescent material coated with a compound represented by formula (I) or a degradation product thereof can function as a marker for a specific substance in a living organism by reacting with a functional molecule such as an antibody (peptide linkage and the like).

What is claimed is:

1. A nanoparticle fluorescent material of metal oxide or metal sulfide which is surface modified by a surface modification agent,
wherein a half width of emission spectrum is 50 to 200 nm, and
the surface modification agent is a compound represented by formula (I) or a degradation product thereof,
M-(R)₄ formula (I)
wherein M is an Si or Ti atom, R is an organic group, and the R groups may be the same or different from each other, but at least one R group is a group having reactivity with an affinity molecule.

2. The nanoparticle fluorescent material of claim 1, wherein the nanoparticle fluorescent material is a doped type containing 0.01 to 10 atom % of a metal ion different from a metal in the metal oxide or metal sulfide.

3. The nanoparticle fluorescent material of claim 1, wherein the nanoparticle fluorescent material is a nanoparticle fluorescent material of metal oxide.

4. The nanoparticle fluorescent material of claim 2, wherein the nanoparticle fluorescent material is a nanoparticle fluorescent material of metal oxide.

5. The nanoparticle fluorescent material of claim 1, further comprising a functional molecule bonded thereto.

6. The nanoparticle fluorescent material of claim 2, further comprising a functional molecule bonded thereto.

7. The nanoparticle fluorescent material of claim 3, further comprising a functional molecule bonded thereto.

8. The nanoparticle fluorescent material of claim 4, further comprising a functional molecule bonded thereto.

9. A nanoparticle fluorescent material dispersion, wherein the nanoparticle fluorescent material of claim 1 is dispersed in water or a hydrophilic solvent.

10. A nanoparticle fluorescent material dispersion, wherein the nanoparticle fluorescent material of claim 2 is dispersed in water or a hydrophilic solvent.

11. A nanoparticle fluorescent material dispersion, wherein the nanoparticle fluorescent material of claim 3 is dispersed in water or a hydrophilic solvent.

12. A nanoparticle fluorescent material dispersion, wherein the nanoparticle fluorescent material of claim 4 is dispersed in water or a hydrophilic solvent.

13. A nanoparticle fluorescent material dispersion, wherein the nanoparticle fluorescent material of claim 5 is dispersed in water or a hydrophilic solvent.

14. A nanoparticle fluorescent material dispersion, wherein the nanoparticle fluorescent material of claim 6 is dispersed in water or a hydrophilic solvent.

15. A nanoparticle fluorescent material dispersion, wherein the nanoparticle fluorescent material of claim 7 is dispersed in water or a hydrophilic solvent.

16. A nanoparticle fluorescent material dispersion, wherein the nanoparticle fluorescent material of claim 8 is dispersed in water or a hydrophilic solvent.

17. The nanoparticle fluorescent material of claim 1, wherein the group having reactivity with an affinity molecule has an amino group at a terminal through a linking group.

18. The nanoparticle fluorescent material of claim 1, wherein at least one R is a substituted or unsubstituted alkoxy group or phenoxy group having a total carbon number of eight or below.
